(19) United States
(12) Patent Application Publication
(10) Pub. No.: US 2014/0177225 A1
(43) Pub. Date: Jun. 26, 2014

(54) NOVEL LED LAMP

(71) Applicant: Wen Chung Tsao, GUANGDONG (CN)

(72) Inventor: Wen Chung Tsao, GUANGDONG (CN)

(21) Appl. No.: 13/759,965

(22) Filed: Feb. 5, 2013

(30) Foreign Application Priority Data
Dec. 20, 2012 (CN) 201220709897.1

(51) Int. Cl. F21V 29/00

(52) U.S. Cl. CPC F21V 29/004
USPC 362/294

(57) ABSTRACT

A novel LED lamp is provided, comprising a fixed plate. The front side of the fixed plate is equipped with an LED lamp and a light-transmitting shade covering the LED lamp, while the back side of the fixed plate is equipped with a lampshade and a radiator; the lampshade is provided with an electric cavity; a driver connected with the LED lamp through a wire is arranged in the electric cavity; the electric cavity is provided with an electric cover plate; and the electric cover plate is provided with a light-operated switch. The utility model provides high illumination and is difficult to damage.

### BACKGROUND OF THE INVENTION

The utility model relates to a lamp, especially an LED lamp as an outdoor garden lamp and small streetlamp.

As a novel energy-saving light source, LEDs have been rapidly developed in virtue of advantages of high light efficiency, long service life and low thermal illumination. The LED lamp is also popularized and applied in the fields of outdoor garden lamps and small streetlamps.

Currently, there are two methods for manufacturing the LED-type garden lamp and street lamp available on the market.

One method: the traditional HID lamp or fluorescent lamp is used; the LED driver is placed at the space where the original electronic elements, such as the ballast and trigger, were located; the LED and optical components thereof are fixed together on the auxiliary radiator with heat conduction and heat dissipation functions; and then the heat is dissipated to the surface of the lamp through the auxiliary radiator. The lamp with such structure is designed by using the traditional HID or fluorescent lamp as the light source, and the light source of the traditional lamp itself does not generate a bad effect when the temperature rises, so enough external heat dissipation surface area is not dedicatedly designed. However, one of the most important factors in application of LED is heat dissipation. The temperature of an LED is required to be controlled to be in a normal working scope; otherwise, an overheating LED will cause serious light attenuation, and even greatly shorten the service life. Moreover, the optical component is designed according to the size and feature of the traditional light source. The traditional light source emits light in almost all directions and is located nearly at the geometrical centre of the optical component; while the LED has a unique feature of emitting light in a single direction, and the light-emitting angle of the common large-power LED is about 120°. Thus, the LED equipped with such optical component fails to reach the original light distribution curve of the lamp and has relatively large light losses.

The other method: the radiator is additional arranged on the lamp or is integrally molded with the body of the lamp; electronic devices such as the built-in driver, LED, and light-operated switch are uniformly arranged and fixed from the lower side of the lamp; and then, the necessary shield, sealing ring, and optical component are fixed. Such structure is obviously improved in comparison with the above structure. However, the electronic devices such as the LED, driver, and light-operated switch are still placed in the lamp along the same direction, so the fixed plane of the LED light source certainly cannot be kept as a complete plane but has grooves for installing the electronic parts such as the driver and the light-operated switch, and then the utilization efficiency of the LED radiator is reduced; besides, the positions of the parts inevitably interfere with each other, affecting the appearance, functions and efficiency of the lamp.

In conclusion, the above structures have the following disadvantages:

1. The heat dissipation surface area of the lamp is relatively small, so heat dissipation is not good, which restricts the utilization efficiency of LED, affects the normal use functions of the LED, and wastes a great amount of raw materials of the lamp.

2. The electronic devices such as the LED and the driver are installed in the same direction, which reduces the utilization efficiency of the LED radiator; besides, the positions of the parts inevitably interfere with each other, affecting the appearance, functions and efficiency of the lamp.

3. The conduction pathway between the radiator and the heat source (LED fixing point) is not enough, so the thermal conductivity is low.

### BRIEF SUMMARY OF THE INVENTION

The technical problem to be solved in the utility model is to provide a novel LED lamp with high heat dissipation.

To solve the mentioned technical problem, the utility model adopts the following technical scheme:

A novel LED lamp is provided, comprising a fixed plate. The front side of the fixed plate is equipped with an LED lamp and a light-transmitting shade covering the LED lamp, while the back side of the fixed plate is equipped with a lampshade and a radiator; the lampshade is provided with an electric cavity; a driver connected with the LED lamp through a wire is arranged in the electric cavity; the electric cavity is provided with an electric cover plate; and the electric cover plate is provided with a light-operated switch.

A sealing ring is arranged between said fixed plate and said light-emitting shade.

Said radiator consists of a plurality of radiating fins which are arrayed on the back side of the fixed plate at an interval.

The profiles of said radiating fins are circular arc-shaped or trapezoid.

Said lampshade, radiator, and fixed plate are integrally structured.

According to the utility model, the LED lamp and the electronic devices, such as the driver and the light-operated switch, are not equipped on the same plane, and the surface where the fixed plate of the LED lamp is installed is not required to be grooved or have other cavities and is kept as a complete plane, which effectively increases the cross section for heat conduction from the LED light source to the outside, reduces the conduction thermal resistance, and accelerates the heat conduction from the LED light source to the outside; a radiator which is integrally formed with the fixing plane of the LED light source is arranged at a position directly above the LED light source where the heat conduction is most effective, and the radiating fins composing the radiator can shape the unique profile of the lamp, thus effectively utilizing the external dimension of the lamp, improving the utilization rate of materials and saving resources. By flexibly utilizing the space and rationally locating the LED driver and the light-operated switch, the lamp structure is maximally used to dissipate heat and configure the electric devices and accessories.

### BRIEF DESCRIPTION OF THE DRAWINGS

FIG. 1 is a structural view of the utility model.

FIG. 2 is a structural view of the utility model in the exploded state.

FIG. 3 is a structural view of the utility model without the lampshade at another visual angle.

### DETAILED DESCRIPTION OF THE INVENTION

To facilitate understanding of those skilled in this field, the utility model is further described with reference to the attached drawings.

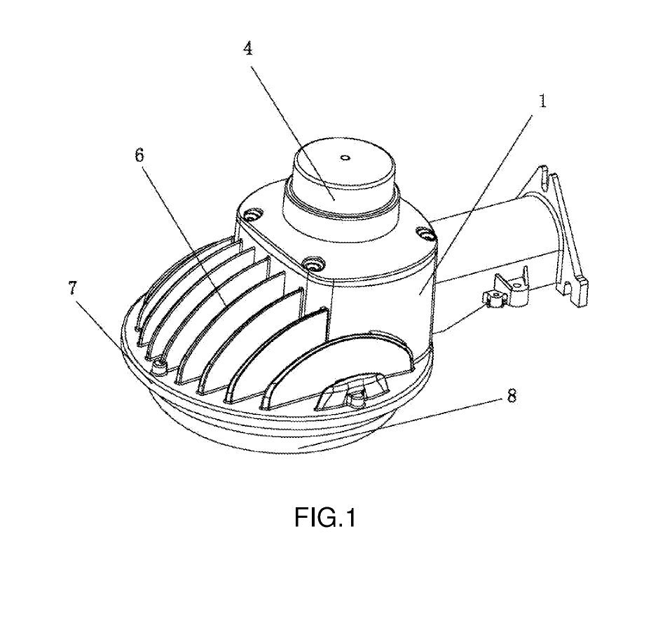

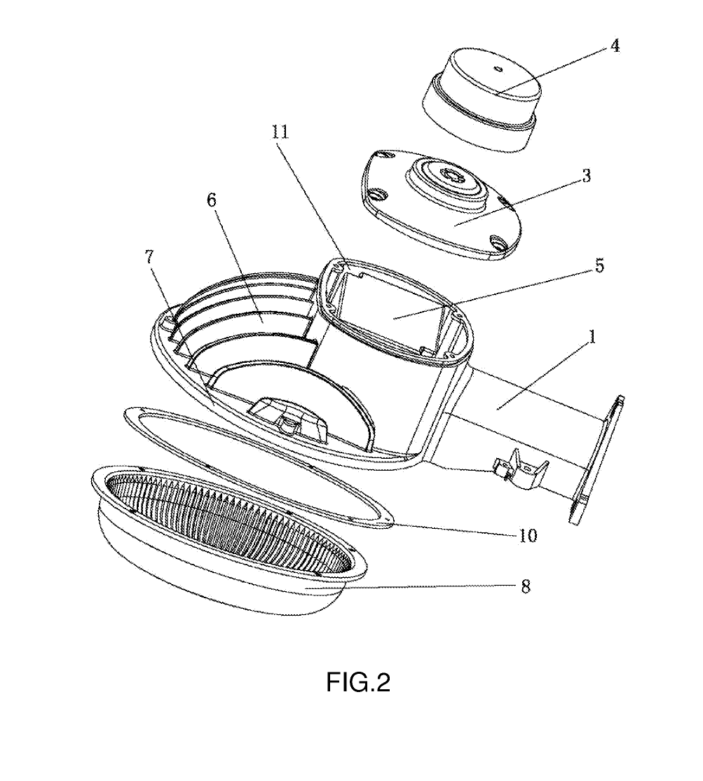

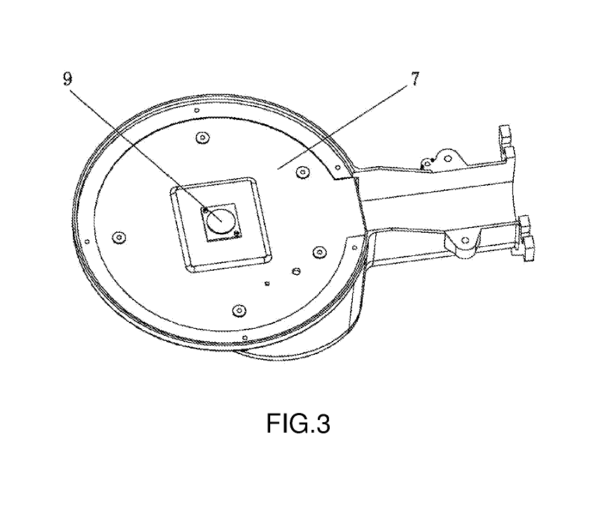

As shown in FIGS. 1, 2 and 3, a novel LED lamp comprises a fixed plate 7; the front side of the fixed plate 7 is equipped with an LED lamp 9 and a light-transmitting shade 8 covering the LED lamp 9, while the back side of the fixed plate 7 is equipped with a lampshade 1; the front side of said fixed plate 7 is a complete plane; the back side of the fixed plate 7 is provided with a radiator 6; the lampshade 1 is provided with an electric cavity 11; a driver 5 connected with the LED lamp 9 through a wire is arranged in the electric cavity 11; the electric cavity 11 is provided with an electric cover plate 3; and the electric cover plate 3 is provided with a light-operated switch 4. The radiator 6 consists of a plurality of radiating fins which are arrayed on the back side of the fixed plate at an interval. The profiles of the radiating fins are circular, arc-shaped, or trapezoid. A plurality of radiating fins are arranged on the back side of the fixed plate in turn, forming the crown of the lamp as a whole. The crown is shaped as a circular truncated cone, spire or others, which is not limited. A sealing ring 11 is arranged between the fixed plate 7 and the light-transmitting shade 8. The sealing ring 11 is installed at edges of the fixed plate 7 on four sides. The lampshade and the sealing ring ensure that the LED lamp is located in a relatively closed space which is well sealed. Practically, the LED lamp is preferably installed in the middle of the front side of the fixed plate.

The front side of the fixed plate 7 is only used for installing the LED lamp 9, so this plane shall be kept flat. The surface of the whole front side is a complete plane, increasing the heat conduction area and improving the heat conductivity. The radiating fins and the lampshade are integrally structured, so the heat generated by the LED lamp can be more effectively dissipated out. The electronic devices, such as the radiating fins and the driver, all are fixed on the back side of the fixed plate; besides, the driver and the light-operated switch all are installed in from the upside and outside of the lampshade, and the light-operated switch which is big in volume and high in reliability can be used, so the whole structure is integrated. The fixed plate is integrated with the radiating fins and the lampshade, so the heat conduction and outward illumination as well as heat dissipation reach the optimal efficiency, and the heat dissipation of the whole lamp is effectively improved. During installation, the connecting end of the lampshade is fixed with the fixed objects.

Finally, it should be specified that the above description is only the preferable embodiment of the utility model, which cannot limit the technical scheme of the utility model. Any equivalent replacement or corresponding improvement of the technical characteristics of the utility model shall be within the protective scope of the utility model.

What is claimed is:

1. A novel LED lamp, comprising a fixed plate (7), wherein the front side of the fixed plate is equipped with an LED lamp (9) and a light-transmitting shade (8) covering the LED lamp, while the back side of the fixed plate is equipped with a lampshade (1); characterized in that the front side of said fixed plate is a complete plane; the back side of the fixed plate is provided with a radiator (6); the lampshade is provided with an electric cavity (11); a driver (5) connected with the LED lamp through a wire is arranged in the electric cavity; the electric cavity is provided with an electric cover plate (3); and the electric cover plate is provided with a light-operated switch (4).

2. The novel LED lamp according to claim 1, characterized in that: a sealing ring (10) is arranged between said fixed plate and said light-emitting shade.

3. The novel LED lamp according to claim 2, characterized in that: said radiator consists of a plurality of radiating fins arrayed on the back side of the fixed plate at interval.

4. The novel LED lamp according to claim 3, characterized in that: the profiles of said radiating fins are circular, arc-shaped, or trapezoid.

5. The novel LED lamp according to claim 4, characterized in that: said lampshade, radiator, and fixed plate are integrally structured.
